(19) United States
(12) Patent Application Publication
(10) Pub. No.: US 2016/0157532 A1
(43) Pub. Date: Jun. 9, 2016

(54) Environmentally Friendly Wetsuit and the Fabrication Process Thereof

(71) Applicant: Min-Chen Shiue, Wujie (TW)

(72) Inventor: Min-Chen Shiue, Wujie (TW)

(21) Appl. No.: 14/559,933

(22) Filed: Dec. 4, 2014

(51) Int. Cl. A41D 13/012; B29C 65/48; B29C 65/00; B29B 11/04

(52) U.S. Cl. CPC A41D 13/012; B29B 11/04; B29C 65/482; B29C 66/71; B29C 66/727; B29C 66/729; B29L 2031/5254

(57) ABSTRACT

A wetsuit comprises applying a water-based polyurethane adhesive in between a rubber sponge layer and a fabric layer to form a laminated sponge sheet, and gluing a water-based polyurethane adhesive or sealant on two butt-spliced ends or edges of two adjoining cut panels as cut from a sponge sheet to form a wetsuit which is environmentally friendly.

### BACKGROUND OF THE INVENTION

A conventional wetsuit may be made by two steps, namely, a rubber sponge being laminated with fabric by gluing a solvent-based adhesive such as polychloroprene adhesive in between the sponge and the fabric to form a sponge sheet; and two adjoining panels as cut from the sponge sheet being connected end-by-end or edge-by-edge such as by butt-spliced adhesion between the two cut panels by using solvent-based adhesive such as polychloroprene adhesive or sealant to form an integrated wetsuit.

However, such a solvent-based adhesive may release toxic organic solvents, such as toluene, xylene and other hazardous solvents during the manufacturing process. Even the emitted toxic solvents or vapors may be recycled in order to reduce their pollution hazard, it is impossible to recycle such toxic matters completely nowadays.

The toxic organic solvents or vapors may cause environmental contamination, influence human health, and may even consume energy and incur cost when removing or recycling such released organic solvents.

It is therefore expected to invent an environmentally friendly or eco-friendly wetsuit to be beneficial to our working or living environment.

### SUMMARY OF THE INVENTION

The object of the present invention is to provide a wetsuit comprising applying a water-based polyurethane adhesive in between a rubber sponge layer and a fabric layer to form a laminated sponge sheet, and gluing a water-based polyurethane adhesive or sealant on two spliced ends or edges of two adjoining cut panels as cut from a sponge sheet to form a wetsuit which is environmentally friendly.

### BRIEF DESCRIPTION OF THE DRAWINGS

FIG. 1 is a flow sheet showing the process step for making the laminated sponge sheet in accordance with the present invention.

FIG. 2 shows a laminated sponge sheet as formed in the present invention.

FIG. 3 shows another laminated sponge sheet as formed in the present invention.

FIG. 4 shows still another laminated sponge sheet as formed in the present invention.

FIG. 5 is an illustration showing the gluing on two spliced ends of two adjoining sponge sheets in accordance with the present invention.

FIG. 6 shows the two panels as adhered, following the step of FIG. 5.

FIG. 7 shows a wetsuit as fabricated in accordance with the present invention.

### DETAILED DESCRIPTION

The process of the present invention may include two general steps for fabricating a wetsuit, namely,
A. Forming rubber sponge sheet; and
B. Integrating any two adjoining panels as cut from the sponge sheet to form the wetsuit.

The process steps are now described in detail as follows:

### A. Forming Rubber Sponge Sheet:

As shown in FIG. 1, a rubber sponge layer 1 (which may be selected from a polychloroprene rubber foam or other foams) is driven by a conveying system to be fed through an adhesive applicator 20, a fabric supplier 30, and a heating system 40 to form a rubber sponge sheet 4 which is a laminated rubber sponge sheet as shown in FIGS. 2˜4.

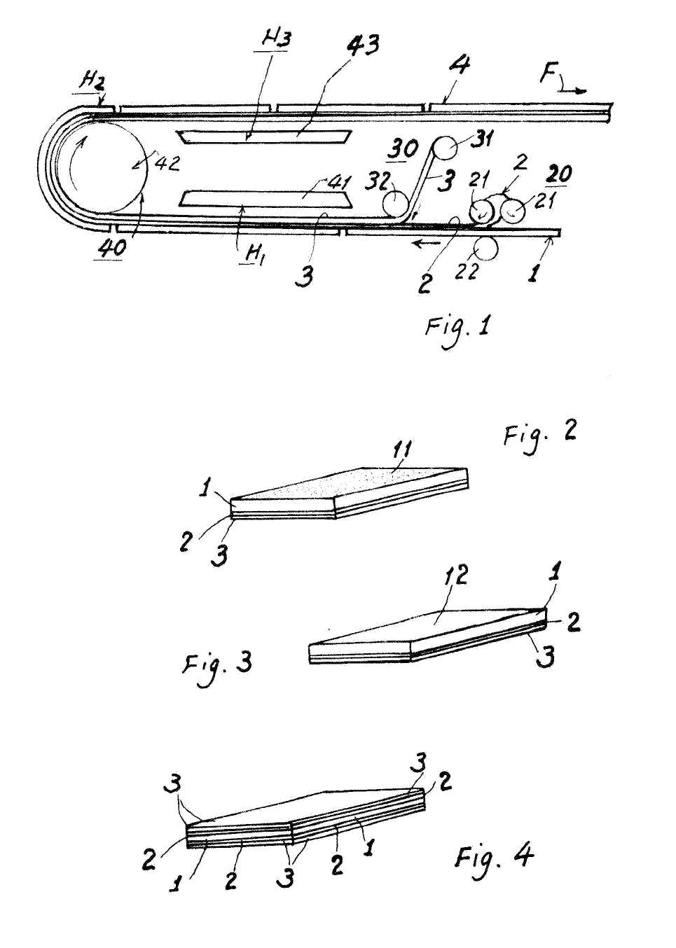

In FIGS. 2 and 3, there is just a single fabric layer 3 laminated with the sponge layer 1. However the sponge layer 1 may be sandwiched in between an outer and an inner fabric layers (FIG. 4) in accordance with the present invention. The rubber sponge layer 1 may be coated with PU or other coatings 11 (FIG. 2); or may be protected by a rubber skin 12 (FIG. 3). Such coating 11 or skin 12 may be surface-formed on the sponge layer 1 by the conventional methods.

Such a protective coating for covering the sponge layer may be a hydrophobic anti-microbial coating or any other protective skins or materials, not limited in this invention.

The adhesive applicator 20 includes: a pair of feeding rollers 21 for quantitatively distributing water-based polyurethane adhesive 2 onto the surface of the fed sponge layer 1, and a backing roller 22 underlay the sponge layer 1.

The water-based polyurethane (or PU) adhesive 2 may be adjustably controlled to meet the following requirements or operation data:

1. Curing agent . . . 2˜5 wt % (based on 100 wt % of the adhesive)
2. Solid content . . . 49˜55 wt % (based on 100 wt % of the adhesive)

### 3. Viscosity . . . 2000˜8000 cps

4. Gluing quantity (or adhesive thickness) . . . 30˜120 g/m²

The fabric supplier 30 includes a fabric reel 31 for supplying fabric layer 3 downwardly, and a pressing roller 32 for guiding the fabric layer 3 to be forcibly laminated with the sponge layer 1 as adhered by the adhesive 2 in between the fabric layer 3 and the sponge layer 1. Such a pressing roller 32 may carry a weight load of 10˜40 kgs to pressurize the fabric layer 3 onto the sponge layer 1 having the adhesive 2 sandwiched between the fabric layer 3 and the sponge layer 1. As aided by the heavy weight of the pressing roller 32, the multiple layers including the fabric layer 3, the adhesive (or adhesive layer) 2 and the sponge layer 1 are primarily laminated which are driven forwardly as shown in arrow direction of FIG. 1.

The fabric as selected for the present invention may include: Nylon, polyester, and Spandex, but not limited.

The heating system 40 includes: a preheating dryer 41 positioned beyond the fabric supplier 30 for preheating the multiple layers comprised of fabric, adhesive and sponge layers, a heat pressing roller 42 positioned beyond the preheating dryer 41 for tensioning and thermally pressing the multiple layers as primarily laminated, and a curing dryer 43 positioned beyond the heat pressing roller 42 for curing the multiple layers as primarily laminated to be a laminated sponge sheet 4 which is driven forwardly by a pulling force F of the conveying system as shown in FIG. 1.

The heating system 40 of the present invention may be divided into three sections as follows:
1. H₁ . . . Preheating section as defined between the fabric supplier 30 and the heat pressing roller 42, having a pre-set temperature of 60˜80° C. and a preheating time duration of 0.5˜1.5 minutes;
2. H₂ . . . Heat pressing section as defined between the preheating dryer 41 and the curing dryer 43, having a pre-set temperature of 80˜110° C. and a heat pressing time duration of 0.5˜1.5 minutes; and
3. H₃ . . . Curing section beyond the heat pressing roller 42, having a pre-set temperature of 90˜110° C. and a curing time duration of 5˜10 minutes.

The laminated sponge sheet 4 as finished in FIG. 1 may be subjected to test to obtain a testing result shown in the following

TABLE 1
Laminated sponge sheet: Nylon (knitted)/Polychloroprene
rubber foam/Nylon (knitted)

| Properties | Result |
|---|---|
| Bonding strength | ⊚ |
| Elasticity | ⊚ |
| Resistance to sea water | ⊚ |
| Solvent resistance | ⊚ |

Notes:
The circle marks as shown in Table 1 are adoptable by the technical fields or manufacturers for making wetsuits by meeting the commercial product levels or requirements in which:
⊚ . . . Excellent
◯ . . . Good

The foregoing operation data, such as contents of the adhesive, viscosity and gluing quantity of the adhesive are very important in order to obtain a commercially adoptable level by the present invention.

Most essentially, the heating or curing steps in the present invention (as shown in FIG. 1) are the most important because the three sections, namely, H₁, H₂ and H₃, which may preheat, heat under pressure, and cure the laminated sponge sheet 4 stepwise. Therefore, the laminated product should be heated and cured gradually to vaporize or release the water as contained in the laminated product in order to minimize the water or moisture content as existing in the final sponge sheet.

Otherwise, too fast drying and curing of the adhesive may not completely release the water in the adhesive. In other words, the water molecules may be “trapped” in the cured structure of the adhesive without being removed in such a quicker time so that the water as remained may cause irreversible degration of the adhesive polymer, thereby deteriorating the mechanical properties of the adhesive and affecting the product quality of the wetsuit.

Meanwhile, the stepwise heating and curing of the present invention may help develop the mechanical or chemical properties of the product more stably and reliably.

Accordingly, the stepwise drying and curing, namely, H₁˜H₃, as taught by the present invention plays an essential and important role for the present invention.

B. Integrating Panels as Cut from Rubber Sponge Sheet:

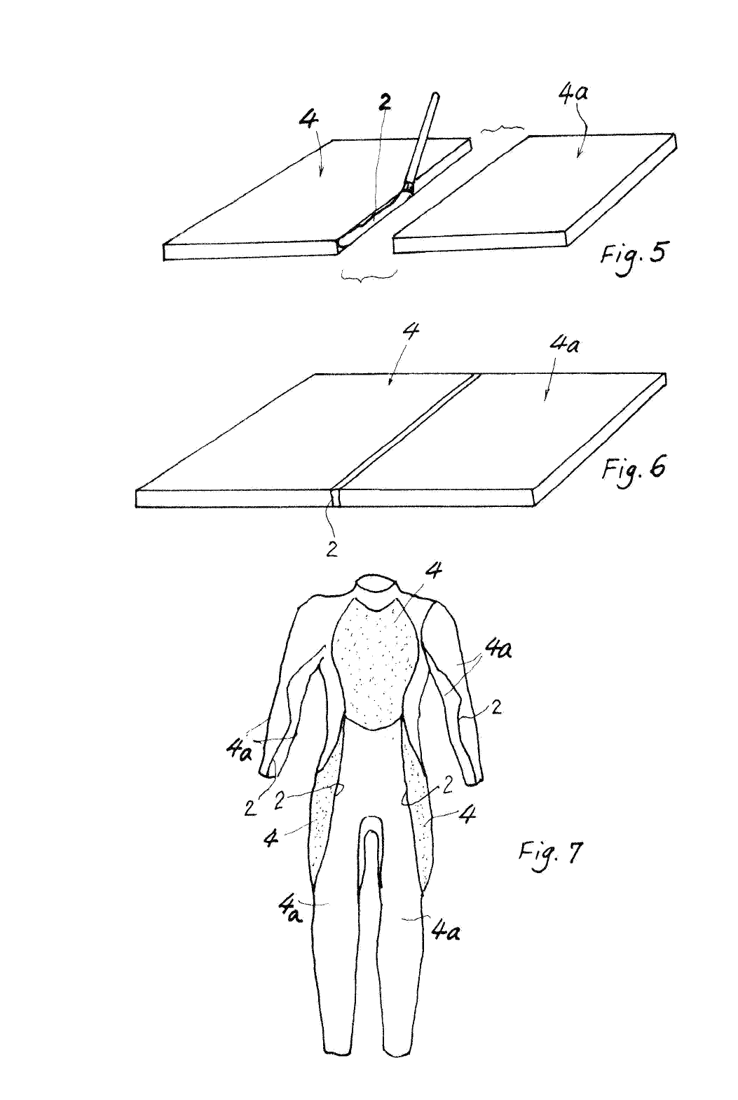

As shown in FIGS. 5˜7, the laminated rubber sponge sheet 4 as obtained by the afore-mentioned process and FIG. 1 (as cut to the desired size) may be further patterned to form panels. The two adjoining panels may be glued with the water-based polyurethane adhesive 2 to each other and then integrated to form the wetsuit product as shown in FIG. 4.

As shown in the FIGS. 5 and 6, the laminated sponge panel 4 is glued end-by-end or edge-by-edge and connected with non-laminated sponge panel 4a to integrate a wetsuit of the present invention. A butt-spliced adhesion method may be used in the present invention.

The adjoining panels may be adhered with the following steps:
1. Primarily gluing the butt-spliced ends or interfaces of two adjoining panels of laminated sponge with fabric with water-based polyurethane adhesive; and drying the adhesive naturally (without additional heating):
   (Note: The panels may be stacked as a pile and then glued, but not limited in this invention.)
2. Secondarily gluing the spliced ends of two adjoining panels with the water-based polyurethane adhesive added with a curing agent of 2˜7 wt % (based on 100 wt % of adhesive); and then dried in an oven for 2˜10 minutes by keeping a temperature of 30˜60° C.; and
3. Finally setting the dried panels as connected to each other within 10 minutes to allow the bonding of the adhesive as glued on the butt-spliced ends or edges of the connected panels, thereby developing the bonding strength of the adhesive. Concerning the requirements for some textile materials, the butt-spliced adhesion joints may be further pressed for enhancing the bonding strength. An integrated wetsuit product, as finished, may be then tested to obtain the results as shown in the following Table 2:

TABLE 2
Laminated sponge panels; Nylon (knitted)/Chloroprene
sponge/Nylon (knitted)

| Properties | Result |
|---|---|
| 1 inch Breaking strength | 6.34 kg/In |
| (Standard: 4.5 kg/In) | |
| Elasticity | ⊚ |
| Heat durability | ⊚ |

Note:
⊚ . . . Excellent as adopted by the manufacturers in the technical field for making wetsuit.

In these steps, there are two gluing steps by first gluing without adding curing agent in the adhesive, and then by second gluing as added with curing agent (2˜7 wt %) and dried in the oven for heat adhesion.

By the way, the water or moisture contained in the adhesive may be completely removed to prevent from degration of the adhesive, and the mechanical properties of the wetsuit product can be stably developed.

The present invention utilizes the non-toxic water-based polyurethane adhesive or sealant to have the following advantages:
1. No toxic organic solvents or vapors are released for preventing air pollution or contamination.
2. No hazardous vapors or irritating odor are emitted in the working environment, which is beneficial for labor health and safety.
3. Since the product quality is not inferior to the conventional solvent-based adhesive and is adoptable by the technical fields of wetsuit, the production cost may be reduced because no additional cost is required to remove or recycle the toxic organic vapors as emitted by the conventional process which incorporates the use of solvent-based adhesive.

So, the present invention is environmentally friendly or eco-friendly.

The present invention may be further modified without departing from the spirit and scope of the present invention.

The term “water-based” PU designated in this invention may also be comprehensively explained as “water-soluble” or “water-borne”, not limited.

The laminated sponge panel may also be connected with another laminated sponge panel by using the water-based PU adhesive. A non-laminated sponge panel may also be connected with another non-laminated panel by using the water-based PU adhesive.

I claim:

1. A process for making wetsuit comprising:
A. Forming a rubber sponge sheet; and
B. Integrating any two adjoining panels as cut from the sponge sheet to form a wetsuit;
wherein said rubber sponge sheet is formed by laminating a rubber sponge layer with at least a fabric layer having a water-based adhesive including a water-based polyurethane adhesive adhered in between said sponge layer and said fabric layer; and
said two adjoining panels are adhered to each other by butt-spliced adhesion by a water-based adhesive including water-based polyurethane adhesive for adhering the two adjoining panels to form the wetsuit.

2. A process according to claim 1, wherein said rubber sponge layer is driven by a conveying system to be fed through an adhesive applicator, a fabric supplier, and a heating system to form a laminated rubber sponge sheet.

3. A process according to claim 2, wherein said adhesive applicator includes: a pair of feeding rollers for quantitatively distributing a water-based polyurethane adhesive onto a surface of the sponge layer, and a backing roller underlay the sponge layer.

4. A process according to claim 2, wherein said water-based polyurethane adhesive is adjustably controlled to meet the following requirements or operation data:
Curing agent . . . 2˜5 wt % (based on 100 wt % of the adhesive);
Solid content . . . 49˜55 wt % (based on 100 wt % of the adhesive);
Viscosity . . . 2000˜8000 cps; and
Gluing quantity (or adhesive thickness) . . . 30˜120 g/m².

5. A process according to claim 2, wherein said fabric supplier includes a fabric reel for supplying fabric layer downwardly, and a pressing roller for guiding the fabric layer to be forcibly laminated with the sponge layer as adhered by the adhesive in between the fabric layer and the sponge layer.

6. A process according to claim 5, wherein said pressing roller includes a weight load of 10˜40 kgs adapted to pressurize the fabric layer onto the sponge layer having the adhesive sandwiched between the fabric layer and the sponge layer.

7. A process according to claim 2, wherein said heating system includes: a preheating dryer positioned beyond the fabric supplier for preheating the multiple layers comprised of fabric, adhesive and sponge layers, a heat pressing roller positioned beyond the preheating dryer for tensioning and thermally pressing the multiple layers as primarily laminated, and a curing dryer positioned beyond the heat pressing roller for curing the multiple layers as primarily laminated to be a laminated sponge sheet which is driven forwardly by a pulling force of the conveying system.

8. A process according to claim 7, wherein said heating system is divided into three sections which include:
H₁ . . . Preheating section as defined between the fabric supplier and the heat pressing roller, having a pre-set temperature of 60˜80′C and a preheating time duration of 0.5˜1.5 minutes;
H₂ . . . Heat pressing section as defined between the preheating dryer and the curing dryer, having a pre-set temperature of 80˜110° C. and a heat pressing time duration of 0.5˜1.5 minutes; and
H₃ . . . Curing section beyond the heat pressing roller, having a pre-set temperature of 90˜110′C and a curing time duration of 5˜10 minutes.

9. A process according to claim 1, wherein said two adjoining panels are adhered with the following steps:
A. Primarily gluing the spliced ends or interfaces of two adjoining panels of laminated sponge with fabric with water-based polyurethane adhesive; and drying the adhesive naturally;
B. Secondarily gluing the spliced ends of two adjoining panels with the water-based polyurethane adhesive added with a curing agent of 2˜7 wt % (based on 100 wt % of adhesive); and then dried in an oven for 2˜10 minutes by keeping a temperature of 30˜60° C.; and
C. Finally setting the dried panels as connected to each other within 10 minutes to allow the bonding of the adhesive as glued on the butt-spliced ends or edges of the connected panels, thereby developing the bonding strength of the adhesive and finally obtaining an integrated wetsuit product.

10. A process according to claim 9, wherein said steps for adhering said two adjoining panels further comprising:
D. Further pressing the butt-spliced ends of the connected panels as connected through steps A, B and C as set forth in claim 9 for enhancing the bonding strength therebetween.

11. A wetsuit as fabricated with the process as claimed in claim 1.
